(19) United States
(12) Patent Application Publication
(10) Pub. No.: US 2008/0133671 A1
(43) Pub. Date: Jun. 5, 2008

(54) INSTANT ANSWERING

(75) Inventor: Chris T. Kalaboukis, Los Gatos, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/565,594

(22) Filed: Nov. 30, 2006

(51) Int. Cl. G06F 15/16

(52) U.S. Cl. 709/206

(57) ABSTRACT

A device, system, and method are directed towards facilitating receiving and responding to questions from a client device. A real time communication mechanism such as instant messaging may be used to communicate with a client device and a community of responders. Questions are received from client devices, processed, and sent to a community of responders. Responses from the community of responders are received and aggregated, and an aggregated response is sent to the client device. The aggregated response may indicate a ranking or other indication of popularity of multiple answer items, based on a number of responders selecting each answer item. A time out period may be used to facilitate quick answers to users.

### FIELD OF THE INVENTION

The present invention relates generally to question answering systems and, more particularly, but not exclusively to using a community to answer questions.

### BACKGROUND OF THE INVENTION

The Internet provides a number of mechanisms that allow a user to find answers to questions. Search engines allow a user to search for web pages by using keywords or other criteria. A search engine typically uses algorithms to retrieve and order relevant results, such as web pages or other documents. Typically, a user of a search engine reads one or more of the document results, in order to determine the answer to a question.

Yahoo! Answers is a network answering system in which a user may submit a question. One or more people from an answering community may submit an answer to the question. Answers can be submitted over a period of hours or days. The user can return to the site hours or days after submitting a question to view the submitted answers.

Many users desire improved or alternate ways of obtaining answers to their questions, particularly in mobile environments. For example, there may be situations when a user may desire an answer to a question in a short amount of time. There may be situations when a user may like to receive answers from many people, but reading answers from many people can be time consuming. There may be other situations in which existing question and answer systems do not provide a user with the capabilities that they desire. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a network device that may be employed in a system implementing the invention;

FIG. 3 is a logical flow diagram generally showing one embodiment of a process for providing answers to user questions;

FIG. 4 is a logical flow diagram generally showing, in further detail, portions of the process illustrated in FIG. 3; and

FIG. 5 is a logical flow diagram generally showing, in further detail, portions of the process illustrated in FIG. 3.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” an item, such as a request, response, or other message, from a device or component includes receiving the message indirectly, such as when forwarded by one or more other devices or components. Similarly, “sending” an item to a device or component includes sending the item indirectly, such as when forwarded by one or more other devices or components.

As used herein, the term “client application” refers to an application that runs on a client computing device. A client application may be written in one or more of a variety of languages, such as ‘C’, ‘C++’, ‘J2ME’, ‘Brew”, Java, and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Briefly stated, the present invention is directed towards providing users with quick answers to questions. Mechanisms of the invention may enable a community of responders to receive a question and submit responses. A server may receive and aggregate the responses, and send an aggregated response to the user. An aggregated response incorporates responses from the community, and may indicate a popularity of one or more answers received from the community of responders.

The mechanisms of the invention may include determining a set of target responders to associate with a question received from a client device, sending to each target responder a representation of the question, receiving from at least a portion of the target responders a response, aggregating the received responses, and sending the aggregated response to the client device. The question may be an open ended question, a YES/NO question, or a multiple choice question. Aggregating responses may include determining a number of responses corresponding to each answer item, and providing an indication of a popularity of each answer item. Aggregating responses may include determining answers that are substantially similar and attributing such responses to a single answer item.

Systems and methods of the invention may include use of a timeout period for receiving responses, and use of synchronous or real time messaging mechanisms, in order to return to a client device an answer in a short amount of time, such as within an instant messaging session, or the like.

Mechanisms of the invention may include processing a question received from a client device in a variety of ways. One such way is to analyze and convert an open ended question into a YES/NO or multiple choice question. Mechanisms of the invention may also make determinations to selectively include one or more advertisements with the aggregated response, based on the question, the responses, the popularity of answers, or other factors.

### Illustrative Operating Environment

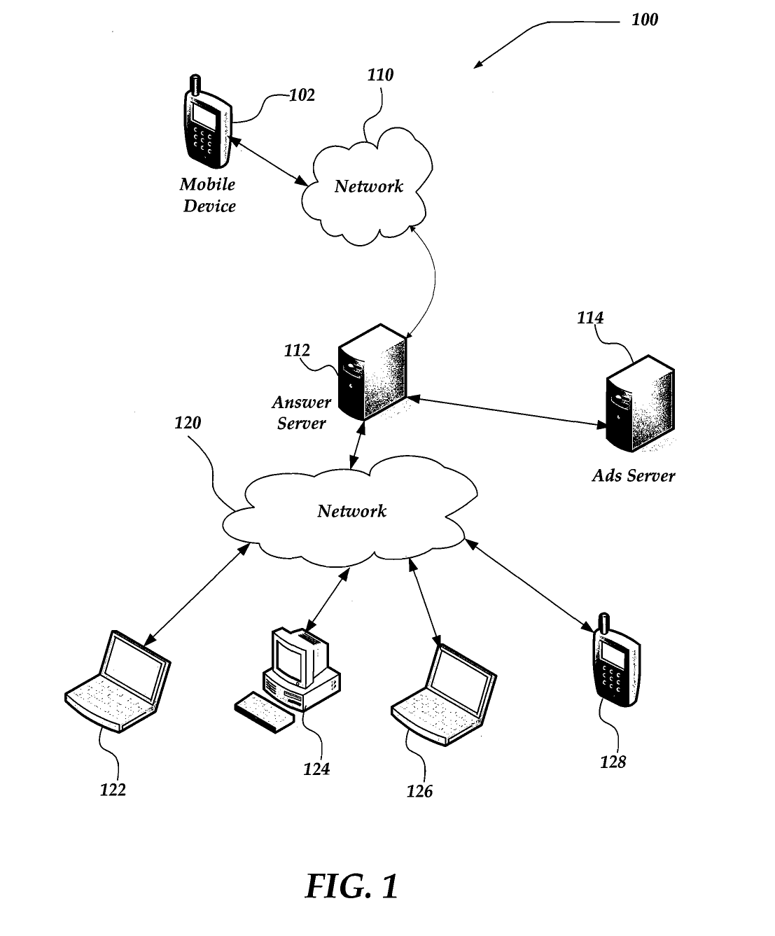

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes a client device, in particular mobile device 102. The system also includes network 110, answer server 112, ads server 114, network 120, and responder client devices 122-128.

A variety of client devices may be employed in accordance with the invention. The client devices may include mobile devices, digital home clients such as personal computers and media centers, and other client devices. Generally, mobile device 102 may include virtually any portable computing device capable of receiving and sending a message over a network, such as network 110, or the like. Mobile device 102 may also be described generally as a client device that is configured to be portable. Mobile device 102 may have the capability of connecting to a network using wireless technology, wired technology, or a combination of both wired and wireless technologies. Thus, mobile device 102 may include virtually any portable computing device capable of connecting to another computing device and receiving information. Such devices include portable devices such as cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile device 102 typically ranges widely in terms of capabilities and features. For example, a cell phone may have a numeric keypad and a few lines of monochrome LCD display on which only text may be displayed. In another example, another cell phone or web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, video, multimedia, and the like, employing virtually any web based language or protocol, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile device 102 may include one or more other client applications that are configured to receive content from another computing device. The client application may include a capability to provide and receive textual content, graphical content, audio content, video content, and the like. The client application may further provide information that identifies itself, including a type, capability, name, and the like. In one embodiment, mobile device 102 may uniquely identify itself through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to answer server 112 or other computing devices.

Mobile device 102 may also be configured to communicate a message, such as through Short Message Service (SMS), Multimedia Message Service (MMS), instant messaging (IM), internet relay chat (IRC), Mardam-Bey's IRC (mIRC), Jabber, and the like, between another computing device, such as answer server 112, another web server, or the like. However, the present invention is not limited to these message protocols, and virtually any other message protocol may be employed.

Mobile device 102 may be further configured to enable a user to participate in communications sessions, such as IM sessions. As such, mobile device 102 may include a client application that is configured to manage various actions on behalf of the client device. For example, the client application may enable a user to interact with the browser application, email application, IM applications, SMS application, and the like. Yahoo! Messenger, provided by Yahoo!, is an example of an IM client and IM protocol. Request for Proposal (RFC) 2779, available at http://www.ietf.org/rfc/rfc2779.txt?number=2779, and RFC 2778, available at http://www.ietf.org/rfc/rfc2778.txt?number=2778, describe proposals for instant messaging protocol standards and an instant messaging service, though the present invention described herein is not limited to these proposals, and at least some of the features or components of the proposals are not required to implement the present invention. Generally, instant messaging provides an ability for at least two computing devices to exchange messages in real time.

Mobile device 102 may further be configured to include a client application that enables the end-user to log into an end-user account that may be managed by a network application. Such an end-user account, for example, may be configured to enable the end-user to receive emails, send/receive IM messages, SMS messages, access selected web pages, maintain a digital wallet, or the like.

Network 110 is configured to couple mobile device 102, as well as other client devices not illustrated, and their components, with other network devices, such as answer server 112, and the like. Network 120 is configured to couple responder client devices 122-128 with answer server 112.

Though for illustrative purposes network 110 and network 120 are shown separately, in various environments employing the present invention, network 110 and network 120 may be the same network, different networks, or different networks including a combination of overlapping components and distinct components. The discussion herein that describes network 110 may therefore be applicable to describe network 120.

Network 110 may include any of a variety of wired or wireless sub-networks that may further overlay stand-alone ad-hoc networks, and the like, to provide an infrastructure-oriented connection for mobile device 102. Such sub-networks may include mesh networks, Wireless LAN (WLAN) networks, cellular networks, and the like. Additionally, network 110 may connect to mobile devices with a wired connection, such as cable, phone lines, Ethernet wires, and the like. Network 110 may include wide area networks, such as the Internet. The invention may be used either generally with networks, specifically with wireless networks, or with various combinations of wireless and wired networks.

Network 110 may further include an autonomous system of terminals, gateways, routers, and the like connected by wireless radio links, and the like. These connectors may be configured to move freely and randomly and organize themselves arbitrarily, such that the topology of network 110 may change rapidly.

Network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile device 102 with various degrees of mobility. For example, network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, network 110 may include virtually any communication mechanism by which information may travel between mobile device 102 and another computing device, network, and the like.

Network 110 may further include or employ one or more network gateways (not shown) that serve as intermediaries between mobile device 102 and other network devices, such as answer server 112. A network gateway may receive data from a device or network, transform the data, and forward the data to another device or network. A network gateway may perform a transformation in more than one direction. Transformation may, for example, include modifying protocols or communications mechanisms in order to facilitate communication between two devices or two networks, each of which may employ differing protocols. A WAP gateway is one type of network gateway. A WAP gateway may facilitate communication between a first device that uses the Wireless Application Protocol (WAP), and a second device. The second device may, for example, communicate using the HyperText Transfer Protocol (HTTP). An SMS gateway is a network gateway that facilitates communication between a device using the Short Message Service (SMS) protocol and another device, such as one using HTTP. A WAP and SMS gateway combines the features of a WAP gateway and an SMS gateway.

In one embodiment, network 110 may include one or more components of an instant messaging service that operates to facilitate communication of instant messaging between mobile device 102 and answer server 112.

FIG. 1 shows mobile device 102 communicating with answer server 112, and answer server 112 communicating with ads server 114. FIG. 1 also shows answer server 112 communicating with responder client devices 122-128. Each of these communications may employ a direct connection, or one or more networks, or a combination thereof. For illustrative purposes, FIG. 1 does not show communication between answer server 112 and ads server 114 employing network 120, however environments that include this communication may be employed with the present invention. In particular, answer server 112 and ads server 114 may employ any one or more of direct communication, a local area network, or a wide area network, such as network 120.

A network enabling any one or more of the above communications may employ any form of computer readable media for communicating information from one electronic device to another. Also, the network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, the network includes any communication method by which information may travel between answer server 112, ads server 114, responder client devices 122-128, and other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Responder clients 122-128 are computing devices that may be employed by a user, referred to as a responder, for receiving and responding to questions. A variety of responder client devices may be employed in accordance with the invention. Responder client devices may include mobile devices, digital home clients such as personal computers and media centers, and other client devices. Generally, responder clients may include virtually any computing device, portable or non-portable, capable of receiving and sending a message over a network, such as network 120, or the like. Responder clients may include devices such as mobile device 102 described herein. Though FIG. 1 illustrates only four responder clients 122-128, it is envisioned that the invention may be practiced in an environment that include a large community of responder clients. Thus, responder clients may number in the hundreds, thousands, hundreds of thousands, millions, or virtually any number. In particular, the invention may be practiced with a number of responder clients that is large enough to make it impractical or very difficult for an asker to view individual answers from all of the responders that may send a response to a question.

Though FIG. 1 illustrates an embodiment of a system having each of network answer server 112 and ads server 114 as separate computing devices, the invention is not so limited. Software, hardware, or hardware-software combinations implementing any portion of these components may be combined with any other component on a single computing device, or arranged in a different manner among multiple computing devices. Some portion or all of the functionality of any component may be distributed or duplicated among multiple computing devices.

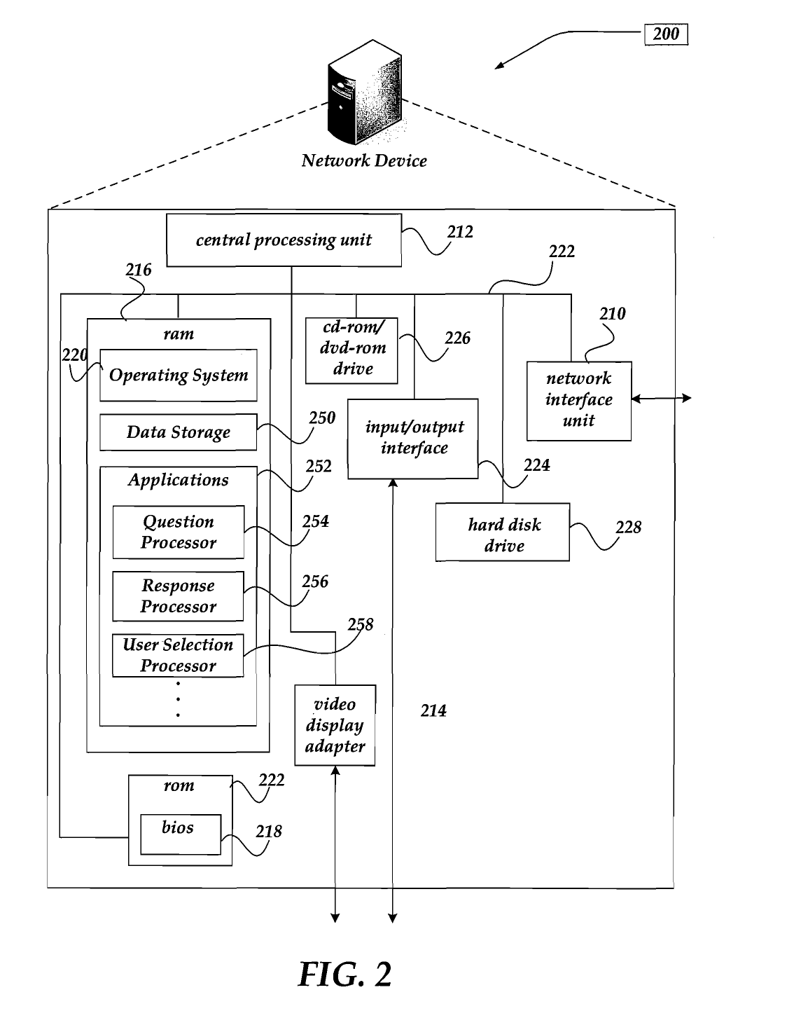

One embodiment of a network device that may be used to implement any one or more of answer server 112 or ads server 114 is described in more detail below in conjunction with FIG. 2. Briefly, however, such network devices may include any computing device capable of communicating with other network devices to enable network applications or web sites to process and respond to requests from client devices, such as mobile device 102. Devices that may operate as these network devices include personal computers desktop computers, multiprocessor systems, microprocessor-based or programmable consumer electronics, network PCs, servers, and the like, or any combination thereof.

FIG. 1 illustrates an embodiment of a system having an ads server 114. Briefly, an ads server provides advertisements, such as banner ads, application ads or other types of advertisements. An application advertisement is an advertisement that is associated with an interaction with an application. It is typically integrated with the application presentation in some way. A search ad is an example of an application ad. When a search is performed, a search application may select one or more ads based on the keywords of the search. The search application may combine search ads with the search results, and present them in an integrated manner. In some embodiments, the integration may be so complete that there is not a clear distinction between the search ads and the search results. In some embodiments, one or more ways of indicating the search ads may be included, such as text, color, line separators, and the like. Similarly, other applications may generate application ads. A mapping application, for example, may use the location specification in a request to generate advertisements based on the location, such as those of businesses in the area, and may display an advertisement on the map.

A banner advertisement typically is placed in a location that is separate from, or more distinguishable from, an application's results. For example, it may be at the top or bottom of a page, or along the margin. A banner advertisement may be selected based on criteria similar to those for an application ad, based on different criteria, or randomly selected

Ads server 114 may have an associated ads database (not shown), which may be integrated or in communication with ads server 114. An ads database may store data pertaining to advertisement contents, constraints, and rules pertaining to the use of each advertisement. At least a portion of the data stored in ads server 114 may be specified by an advertiser. An advertiser may specify data describing the advertisement contents, constraints, and rules pertaining to the use of each advertisement.

Ads server 114 may receive data or a set of parameters to use for determining whether to provide an advertisement, selecting and generating an advertisement, including data upon which various determinations are made. Selecting and generating an advertisement may include selecting an advertiser, selecting an advertisement associated with the advertiser, or selecting content to include in an advertisement. The data upon which these and other determinations may be based may include information derived from a question received by the answer server, one or more responses received from a responder device, an aggregated response, and the like. The data upon which these and other determinations may be based may also include information about the user or mobile device, actions that the user or mobile device have taken, data pertaining to one or more advertisers, relevant events, and a variety of other types of information.

FIG. 1 illustrates an embodiment in which mobile device 102 communicates with answer server 112. A user of mobile device 102, referred to as an “asker,” may employ mobile device 102 to send a question to answer server 112. Answer server 112 may receive and process the question from mobile device 102. Answer server 112 may select a set of responders or responder devices 122-128. A responder is a person who employs a responder device to receive questions and respond to them. Answer server 112 may employ identifiers or addresses of responders, responder devices, or both. It may, for example, employ a login name or email address of a responder. It may employ an IP address, MIN, or other identifier of a responding device. Answer server 112 may employ any one or more of these identifiers or addressing mechanisms when communicating with a responder or responding device. As used herein, unless the context clearly indicates otherwise, the term “responder” may be used to refer to a person, a responder device, or a combination of a person and a responder device.

### Illustrative Network Device Environment

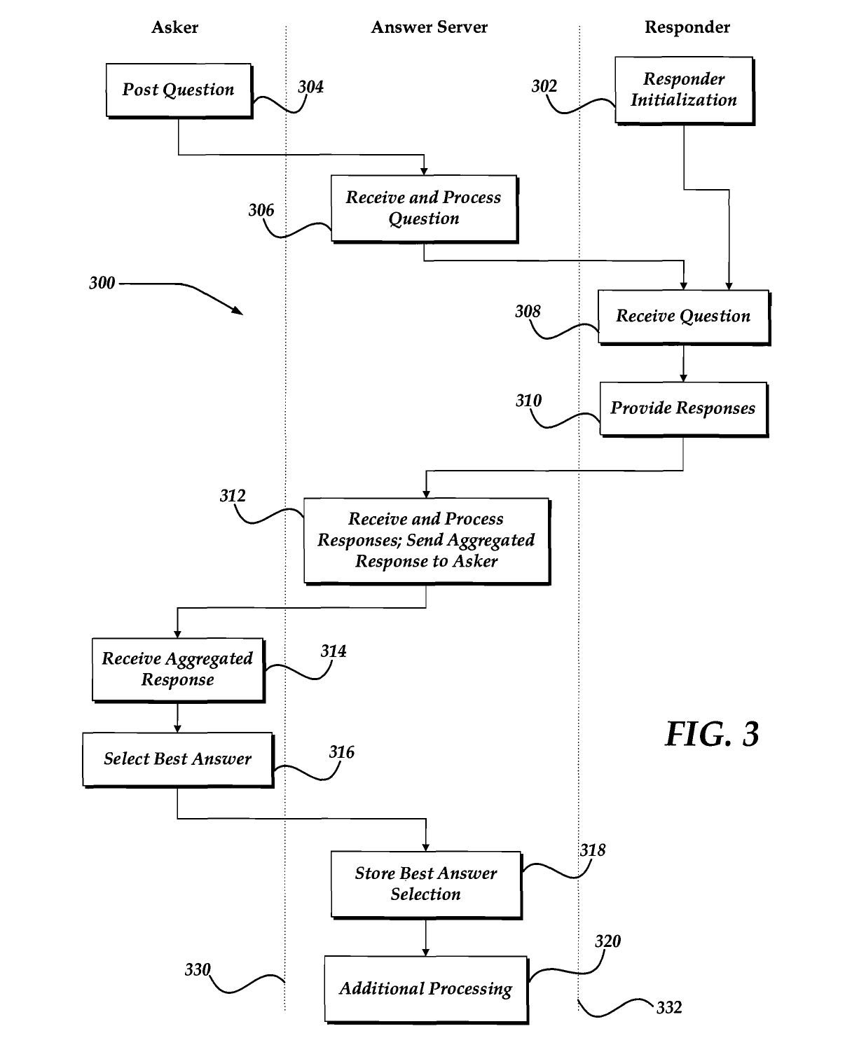

FIG. 2 shows one embodiment of a network device 200, according to one embodiment of the invention. The embodiment of network device 200 illustrated in FIG. 2 may be used to implement the answer server 112 or the ads server 114 of FIG. 1. Network device 200 may include many more components than those shown. It may also have less than all of those shown. The components shown, however, are sufficient to disclose an illustrative embodiment for practicing the invention. One or more network devices, and the application programs integrated with the devices, may be used to implement the processes of the present invention, as illustrated in FIGS. 3-5 and discussed herein.

Network device 200 includes processing unit 212, video display adapter 214, and a mass memory, all in communication with each other via bus 222. The mass memory generally includes RAM 216, ROM 222, and one or more permanent mass storage devices, such as hard disk drive 228, tape drive, optical drive, and/or floppy disk drive. The mass memory stores operating system 220 for controlling the operation of network device 200. Any general-purpose operating system may be employed. Basic input/output system (“BIOS”) 218 is also provided for controlling the low-level operation of network device 200. As illustrated in FIG. 2, network device 200 also can communicate with the Internet, or some other communications network, via network interface unit 210, which is constructed for use with various communication protocols including the TCP/IP protocol. Network interface unit 210 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more data storage components 250 may include program code or data used by the operating system 220 or by applications 252. Data may be stored in ram 216 or other storage devices, such as hard disk drive 228. One or more applications 252 and application components are loaded into mass memory and run on operating system 220. Examples of application programs may include search programs, transcoders, schedulers, calendars, database programs, word processing programs, HTTP programs, customizable user interface programs, IPSec applications, encryption programs, security programs, VPN programs, SMS message servers, IM message servers, email servers, account management and so forth. More detailed discussions of some application programs are included herein.

In one embodiment, applications 252 may include a question processor 254. A question processor may include program logic that performs actions in response to receiving a question from an asker client device. These actions may include determining a timeout period to employ when receiving responses from responders, determining a set of responders to solicit responses from, sending a question to the set of responders, or other actions relating to processing questions.

In one embodiment, applications 254 may include a response processor 256. A response processor may include program logic that performs actions relating to receiving and processing responses. These actions may include receiving and collecting responses, monitoring a timeout period, determining whether a sponsorship related to the question or responses is to be applied, packaging a response to be sent to the asker, or other actions relating to processing responses. In one embodiment, applications 252 may include a user selection processor 258 that performs actions in response to an asker selecting a best or desired answer. These actions are discussed in further detail herein. Though FIG. 2 illustrates a question processor and a response processor, the actions and logic of each component may be combined into a single component, divided into multiple components in a different manner, or distributed in a variety of ways across multiple network devices.

### Generalized Operation

FIG. 3 is a high-level flow diagram of a process 300 for processing and responding to one or more questions in accordance with an embodiment of the invention. Process 300 may employ at least a portion of the system illustrated in FIG. 1. It may employ any of the system variations as discussed herein, or it may be performed with other systems.

FIG. 3 is divided into three areas by two vertical dotted lines 330 and 332. The area to the left of line 330 is labeled as the asker area; the area between lines 330 and 332 is the answer server area; and the area to the right of line 332 is the responder area. Each of the action blocks of FIG. 3 resides within one of the three areas. The areas illustrate, for one embodiment, a component corresponding to each action that may perform the action. The invention is not so limited, however. In various embodiments, each of the actions may be performed by a component other than that illustrated in FIG. 3. Unless clearly limited otherwise herein, any one or more of the actions may be performed by one or more of the components, or by components other than the asker, the answer server, or a responder.

As illustrated in FIG. 3, at block 302, an initialization action is performed. In one embodiment, this action is performed by a responder and an answer server in communication with each other. The initialization action of block 302 may include any one or more of the following actions:

a responder registering as a member or a responder;

a responder logging in;

specification of content for questions that the responder may respond to;

specification of other criteria to use for determining whether to solicit a response from the responder; or

specification of data for identifying or locating the responder, type or capabilities of the responder's client device, and the like.

Specification of content may include various levels of specificity. It may include geographic specifications, level of expertise, or other data that may assist a matching of a question with a set of responders. A responder may specify one or more areas of expertise.

Specification of other criteria may include criteria that may throttle, or otherwise limit the solicitation from the responder. This may include a desired limit to the frequency of questions, a desired time period between questions, times when questions may be submitted or not submitted, or other such data. The action of block 302 may be performed by numerous responders. Responders may number in the thousands, millions, or virtually any other number.

At block 304, an asker may post a question. Posting a question may include specifying a question to be answered and sending the question to the answer server. A question may be specified in one or more of a number of ways. In one embodiment, a question is specified by entering text. As used herein, the term question refers to a specification of a matter that elicits a reply. It may take the form of an interrogatory, a statement, or a single word or phrase that represents a request for a response. Some examples of questions include: “What's a good movie?”, “Looking for a good movie,” or “movie tonight.” A question can be in the form of text, an image, an audio segment, a document, or other forms, or any combination thereof.

An asker of some questions may expect a responder to select one of two or more answer items. One such question is a YES/NO question, which may be responded to with one of two answer items, typically YES or NO. The answer items for a YES/NO question may be ones that generally equivalent, but semantically different, from “yes” and “no,” such as “Buy it”/“Don't buy it”, “Go”/“Don't Go”, “Do it”/“Don't do it”, and the like. As used herein, a YES/NO question includes these, and other variations.

A multiple choice question may be responded to with one of two or more answer items, each answer item corresponding to one of the choices presented by the question. An open question is one in which a responder may respond by entering text and the answer is not limited to a provided set of choices. In a multiple choice question, an asker may have an option of specifying what each possible choice is. An example of a multiple choice question is, “What restaurant should I go to tonight? A) Acme Seafood; B) Joe's Steakhouse; C) Sam's Sushi?” Responders to this question are asked to reply with one of the three proposed answer items. As discussed herein, each responder may respond with a selection of a single answer item. The answer sent to the asker may include multiple answer items. As also discussed herein, an answer to an open ended question may include more than one answer item.

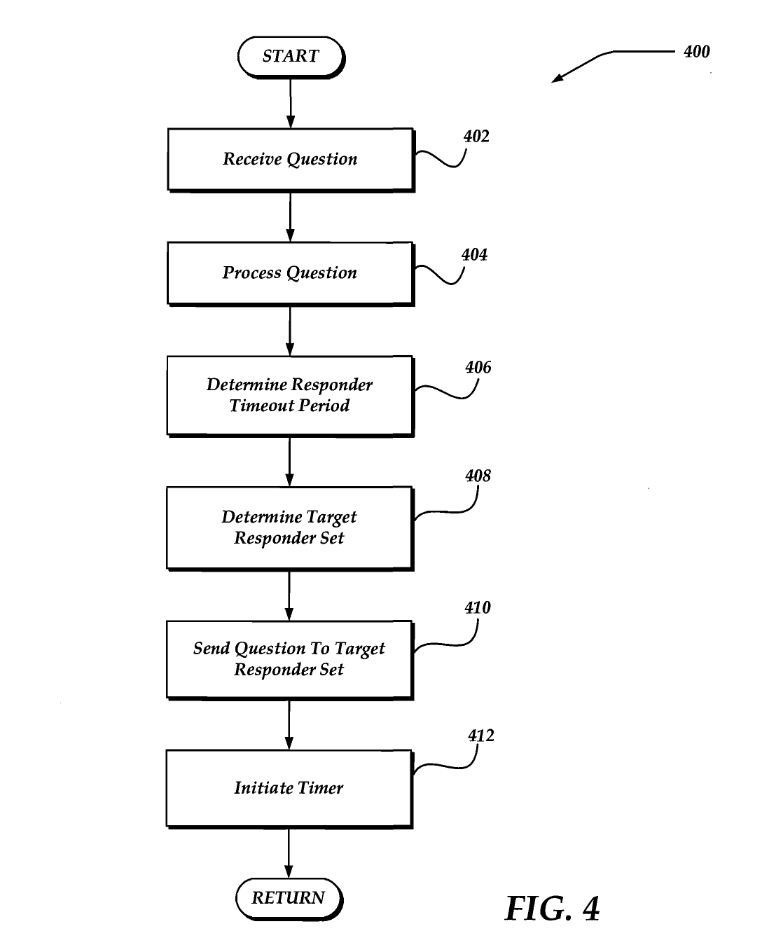

Process flow then proceeds to block 306, where the posted question is received and processed. In one embodiment, this action is performed by an answer server. This action is illustrated in further detail in FIG. 4 and the accompanying text. Briefly, processing a question includes preparing the question for transmitting to responders, determining a set of target responders, sending the question to the target responders, and initiating a timing operation. Processing a question may include adding supplementary information to the question. For example, if a question asks for a suggested movie to see, supplementary information may include a list of movies currently in theaters. As used herein, the term question may include supplementary information that is sent to a responder.

Process may then flow to block 308, where at least a portion of the target responders receive the processed question. As discussed in the text accompanying FIG. 4, the question may be transmitted to responders using any of a number of transmission mechanisms, including instant messaging (IM), SMS, or other communication mechanism. Responders may receive the questions in an IM window, a browser window, an SMS window, and the like. A question, including any supplementary information, may be transmitted using more than one media or communication mechanism. For example, an IM message may include a link to a web page or audio segment containing a part of the question.

Process may then flow to block 310, where one or more of the responders may provide a response to the question. This action may include a responder specifying a response and transmitting the selected response to a server such as the answer server. The format of a response may vary, and may depend on the form of the question. A response may include free text, a selection of YES or NO, a selection of one or more of multiple choices presented, an ordering or ranking of multiple choices, an emoticon, an image, a link, or another form, or any combination thereof. YES or NO questions or multiple choice questions may be responded to with a selection of an image, such as a thumbs up or thumbs down image.

A responder may be presented with information indicating the time period within which she must respond. In one embodiment, a countdown timer is presented to each responder to facilitate timely responses. In one embodiment, program logic on a responder client device for sending a response may be disabled when a designated time period expires.

A response may be transmitted by a responder using the same or different communication mechanism as the one in which the question was received by the responder. The responder may transmit a response using IM, SMS, or other communication mechanism.

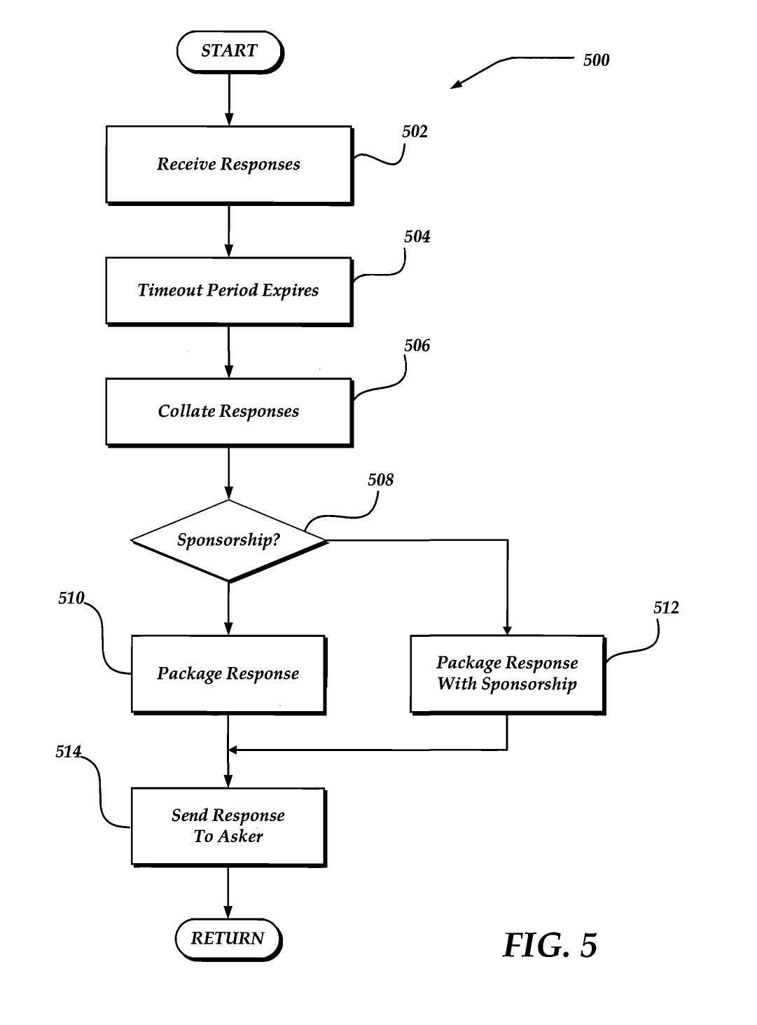

Process may then flow to block 312, where responses sent from responders are received and processed. Responses may be aggregated, and an aggregated and processed response may be sent to the asker. In one embodiment, at least some of these actions are performed by an answer server. This may be the same or a different answer server as the answer server that performed the actions of block 306. The actions of block 312 are illustrated in further detail in FIG. 5 and the accompanying text.

Process may then flow to block 314, where a processed response is received by the asker. A processed response may be presented to the asker in a variety of forms. For example, a YES/NO question may have a corresponding processed response that indicates a percentage of responders for each of YES and NO, or simply a percentage of YES responses. A multiple choice question may have a corresponding response that indicates a percentage of responses corresponding to each choice, or a subset of the choices. The choices may be ordered based on the percentage of responses corresponding to each one, such that the choice having the highest responses is ordered first. This ordering may be referred to as a ranking of the choices. Choices may be ordered based on other criteria, such as sponsorships or other data corresponding to each choice. As discussed in the text accompanying FIG. 5, an open question or responses may be processed so that the processed response appears as a YES/NO or a multiple choice question. The “popularity” of an answer as used herein refers to a percentage or fractional portion of responders, absolute or relative number of responders, or scoring provided by responders that provide or select the answer or associate a score with an answer. Thus, in one embodiment, an aggregated response may include one or more answers with corresponding indications of popularity for each answer.

A processed response received by an asker may include one or more links, phone numbers, or other types of information relating to the response. This information may be displayed on the asker's client device in any of a number of ways. In one embodiment, a response received by an asker may include a sponsor ad. The ad may be selected by the answer server, by another server, or another source.

Process may then flow to block 316, where the asker may select, from the response, an answer item that the asker considers to be the best or most desirable response. For example, if several movies or restaurants are presented in the response, the asker may select the one movie or restaurant that she prefers. The asker's selection may then be sent to a server for additional processing. This server may be the answer server that performed the actions of block 312, another answer server, or another server. Sending the selected answer item may be performed using the same or a different communication mechanism as was used to send the processed response to the asker.

Process may then flow to block 318, where the selection of the best answer item, or other data may be stored or transmitted to another network device for processing or storage. Data that may be stored or transmitted may include the original question, a processed question, identification of the asker, responder responses, identification of responders, an association between each responder and the response received from the responder, the processed response, the number or percentage of responders providing each answer item, the selected best answer item, additional information relating to the question or answer that may have been sent to the responders or to the asker, other related data, or any combination of these. In one embodiment, at least some of the stored data may be stored so that it is available for use in processing subsequent questions or responses. For example, if a substantially identical question is asked a second time within a predetermined time period, an answer server may reply to the asker based on the prior question and answer. It may forego at least some of the actions of sending the question to the responders and receiving responses. In another example, at least some of the processing that is performed at block 306 or 312 may be used to process a subsequent question or responses. In one embodiment responses may be provided to sponsors or other entities that have an interest in the subject matter.

In one embodiment, a question, an answer, percentages of responders providing an answer item, or other saved data may be presented on a web site in a variety of ways. Responses or associated data about products or services may be presented on a web site that reviews, discusses, or provides information about products or services. For example, a web site that provides movie information may indicate a percentage of responders that recommend a particular movie. In another example, a web site providing information about a product may disclose a percentage of responders that recommend the product when compared with other products.

Process flow may then proceed to block 320, where additional system processing may be performed. This may include processes that facilitate maintaining a points or reward system for responders. In one embodiment, responders receive a number of points for responding to a question within the timeout period. The responders may receive an additional number of points for submitting a response that is subsequently selected by the asker as the best or desired response. Points for a responder may be determined based on responses by other responders, such as the correlation between a responder's answer and the answers provided by other responders. The number of points awarded to a responder may also be based on the difficulty of the question, the quantity of responses received, the time of day, or any of a number of other factors.

The number of points that a responder accumulates may be used to provide rewards to a responder. Rewards may be monetary, goods or services of value, access to web services or groups, public recognition, and the like. They may also be used in a determination of whether to include the responder in a target responder group for a subsequent question, whether to retain the responder in the general responder group, or in a weighting system that weights responses based on previous responses by the sending responder.

In one embodiment, all, or at least a portion of the actions of blocks 318 and 320 may be performed by user selection processor component 258 of FIG. 2.

The methods and mechanisms of the invention, discussed herein, facilitate a synchronous, or a substantially synchronous question and answer session for a client device. That is, a user may submit a question and receive a very prompt response in a single session. This may be referred to as a real time communication, or a real time session. The user is not required to return to a web page or client program, or log in, at a later time. A user of a mobile device may have the expectation of receiving a prompt “while-you-wait” answer to facilitate choices, such as a buying decision while in a store, a restaurant or movie decision while near a potential restaurant or theater, and the like.

FIG. 4 is a logical flow diagram generally showing one embodiment of a process 400 for receiving and processing questions from a client device, such as mobile device 102 of FIG. 1. Process 400 corresponds to block 306 of FIG. 2, and illustrates at least some details that may be included in the actions of block 306, or in other parts of the process 300. Process 400 may employ at least a portion of the system illustrated in FIG. 1. It may employ any of the system variations as discussed herein, or it may be performed with other systems. In one embodiment, all, or at least a portion of the actions of process 400 may be performed by question processor component 254 of FIG. 2.

Process 400 begins, after a start block, at block 402, where a question is received from a client device, such as mobile device 102 of FIG. 1. In one embodiment, the action of block 402 is performed by an answer server, such as answer server 112 of FIG. 1. In one embodiment, the transmission of the question from the client device to the answer server may include the use of an instant messaging mechanism. SMS and other messaging mechanisms or communication mechanisms may be used in the transmission or reception of the question. Receiving the question may include extracting identifying information associated with the client device, such as a phone number, email address, location, or a user's identity.

As discussed above, a question may be in any of a number of forms, including open ended questions, YES/NO questions, and multiple choice questions. In one embodiment, an asker may specify a timeout period to be used when collecting responses. In one embodiment, an asker may have access to a set of standard questions, including questions that may have varying answers based on when asked, where asked, or other parameters. Some examples of standard questions are “What movie should I see tonight?” or “What restaurant should I go to in this area?” An asker may select one of these questions for posting. The asker may manually add additional information, such as the city or neighborhood she is in. The asker's client device may automatically, or on command, add information, such as the geographic location. The text of the question or an ID of the standard question may be transmitted. An answer server, upon receiving an ID of a standard question, may perform additional processing, such as inserting text corresponding to the question, or retrieving additional information to supplement the question.

Process flow may then proceed to block 404, where processing of the received question may be performed. Processing may include some of the actions discussed above, such as inserting text corresponding to a standard question, combining location information or other parameters with the question, or retrieving additional information to supplement the question.

In one embodiment, the actions of block 404 may include converting an open question to a YES/NO question or a multiple choice question. This action may include analyzing at least a portion of the question to determine what type of a question it is. For example, a question that begins with “Should I . . . ” may be recognized as a YES/NO question. Processing the question may include determining or retrieving information that is relevant to the question, and including the additional information with the question.

Processing may then flow to block 406, where a responder timeout period is determined. In one embodiment, an answer server has one or more predetermined timeout periods that it uses. For example, the timer may have a timeout period of ten seconds that is always used, used by default if no other periods are determined, or used for some types of questions. In one embodiment, a predetermined timeout period may be configured to be a specific value. For example, a system administrator may configure a duration of a default timeout period to be 10 seconds, 20 seconds, 30 seconds, one minute, two minutes, or virtually any length of time. A timeout period may be determined based on the type of question, for example an open ended question may have a longer timeout period than a YES/NO or multiple choice question. In one embodiment, an asker specifies a timeout period, and the specified timeout period is used. An asker may specify the timeout period in a number of ways. One way is to specify the timeout period as a numeric value. For example, an asker may specify a value such as 10 seconds, 20 seconds, 30 seconds, one minute, two minutes, or any other time value. An asker may select one of several choices for timeout periods, each of which corresponds to a time value used by the answer server. In one embodiment, a timeout period is used such that an asker may post a question and receive an answer within a single session, such as an IM session or a login session.

Process may then flow to block 408, where a target responder set is determined from a responder community. As discussed above, a responder may specify information, such as content areas of expertise, geographic areas, languages spoken, desired frequency of questions, or the like. Any one or more of these specifications may be used to determine an appropriate target responder set. A time since being sent a most recent question may also be used to determine a target responder set. A responder's history may be used; for example, the number of points a responder has received may be a factor.

In one embodiment, determining a target responder set may include selecting responders based on their geographic location or geographic locations in which each responder has expertise. A geographic area may be determined based on an asker's question. A question may explicitly state a geographic area, such as in a question, “Can anyone recommend a dry cleaner in Sunnyvale?” A question may suggest that the answer is to be limited to a geographic area, and the area may be determined based on information received from a client device or from other knowledge of the asker. For example, a client device may transmit a location based on a GPS or other location determination mechanism. In another example, a prior communication from an asker may indicate the asker's location. In one embodiment, a question is analyzed to determine whether a response is to be limited to a geographic area. An analysis may, for example, determine that questions pertaining to certain types of businesses, products, or services are to be limited to a geographic area, while other businesses, products or services are not so limited. For example, an analysis of a question about a dry cleaner may indicate a limited geographic area, while a question about music or a movie may indicate a nationwide or wordwide geographic area.Processing may then flow to block 410, where the processed question, which may include any supplementary information, is sent to each of the responders in the target responder set. A determined timeout period may be sent with the question. In one embodiment, this is transmitted using an IM mechanism. In some embodiments, SMS or other communication mechanisms or protocols may be employed. An answer server may use a first communication mechanism for a portion of the target responder set and a second communication mechanism for a second portion of the target responder set.

Processing may then flow to block 412, where a timer is initiated. The timer may be employed to implement a timeout period for responses, as discussed herein. Initiating a timer may include storing the current time, the time at which the timeout period is to expire, or another related time. Initiating a timer may include initiating a timer process that generates a signal or sets a flag when a specified timeout period expires or a timeout time is reached.

Process 400 may then return to a calling program. In one embodiment, processing may continue at block 308, described in FIG. 3.

FIG. 5 is a logical flow diagram generally showing one embodiment of a process 500 for receiving and processing responses from responder devices, such as responder client devices 122-128 of FIG. 1. Process 500 corresponds to block 312 of FIG. 2, and illustrates at least some details that may be included in the actions of block 312, or in other parts of the process 300. Process 500 may employ at least a portion of the system illustrated in FIG. 1. It may employ any of the system variations as discussed herein, or it may be performed with other systems. In one embodiment, all, or at least a portion of the actions of process 500 may be performed by response processor component 256 of FIG. 2.

Process 500 begins, after a start block, at block 502, where one or more responses are received from responder devices, such as responder client devices 122-128 of FIG. 1. In one embodiment, the action of block 502 is performed by an answer server, such as answer server 112 of FIG. 1. In one embodiment, the transmission of the response from the responder client device to the answer server may include the use of an instant messaging mechanism. SMS and other messaging mechanisms or communication mechanisms may be used in the transmission or reception of the responses.

Receiving a response may include receiving information identifying the corresponding question that was previously sent to the responder. It may include retrieving information identifying the responder. As discussed above, it is envisioned that the invention may be practiced in an environment that include a large community of responder clients. It is further envisioned that the set of target responders, and the number of responses received, may number in the hundreds, thousands, hundreds of thousands, millions, or virtually any number. In particular, the invention may be practiced with a number of responses that is large enough to make it impractical or very difficult for an asker to view individual answers from all of the responders that may send a response to a question.

A received response may include information in one or more of a variety of types or formats. A response may include a text response, a representation of YES or NO, a representation of one or more selections from a multiple choice question, an image, a link, another type of data, or a combination thereof. The actions of receiving responses may include saving the responses, or a representation thereof, and may include saving information associating each responder with the responder's corresponding response.

Process flow may then proceed to block 504, where a timeout period, as discussed above, expires. In one embodiment, expiration of the timeout period indicates that responses received subsequent to the expiration are not to be included when aggregating responses for sending to the asker. In one embodiment, a window of time may follow a timeout expiration, in which at least some responses are included.

Process flow may then proceed to block 506, where processing and aggregating the set of received responses is performed. In one embodiment, these actions may include matching each of at least a portion of the responses with one of a set of answer items. For a YES/NO question, the set of answer items may comprise two answer items, corresponding to YES or NO. A For a multiple choice question the set of answer items may comprise each of the provided choices. In one embodiment, a responder may be permitted to send a response indicating a selection of more than one answer item. A selection of more than one answer item may include an indication of which answer item is the first choice of the responder.

For open ended questions, aggregating responses may include determining a set of duplicate, similar, or nearly identical responses to form a set of answer items, and matching each response with one of the set of answer items. The process may include determining whether a response is to be matched with another response based on variations in spelling, grammar, nomenclature, syntax, semantics, or other differences. For example, responses that indicate a name of a business or product may be matched with identical or very similar responses, based on a determination that the responses are intended to indicate the same business or product. Names that are misspelled or differ slightly may be matched together to an answer item.

When a set of answer items is provided or determined, aggregating responses may include determining a number of responses corresponding to each answer item. The number may represent an absolute number, a relative number, a percentage or fraction of total responses, or the like. In one embodiment, a score is computed that is based on a percentage of responses corresponding to an answer item, weighted by a weighting factor corresponding to at least a portion of the responders. For example, responders having a high score or good record may have the count of their answer considered to be more than one. In one embodiment, responders may select more than one answer item, and a weighting factor may be based on whether a selected answer item is the first choice of the responder.

In one embodiment, at least a portion of the actions of block 506 may be performed prior to actions of block 404, concurrently with actions of block 502, or in other sequences relative to the methods described herein.

Process flow may then proceed to decision block 508, where a determination is made of whether a sponsorship corresponding to the question or response exists and is to be used. This determination may be based on the subject matter of the question, the aggregated responses, or other factors. Rules used for making this determination may be configured by an advertiser. A determination may be based on a question, one or more responses, or an aggregated response. For example, a restaurant advertiser's sponsorship may be determined based on a question regarding a restaurant, an aggregated response having the restaurant as one of the answer items, an aggregated response that excludes the restaurant as one of the answer items, or an aggregated response having the restaurant as the highest ranked answer. In one embodiment, ads server 114 of FIG. 1 may perform a determination of whether a sponsorship is to be used and, if yes, may determine the specific sponsorship to use.

If, at the decision block 508, a determination is made that at least one sponsorship is to be used, process flow may then proceed to block 512, where the aggregated response is packaged together with a sponsorship for presentation to the asker. A sponsorship may be presented in a variety of forms. One such form is a banner ad. One form may be information, such as a phone number, text, image, electronic coupon, link, or the like, to be included with an aggregated response or an answer item. Packaging the aggregated response may include ranking or ordering the answer items, associating values indicative of a number or percentage of responders selecting each answer item, or the like. Process flow may then proceed to block 514.

If, at the decision block 508, a determination is made that there is not a sponsorship to be used, process flow may proceed to block 510, where the aggregated response is packaged for presentation to the asker. Packaging the aggregated response may include ranking or ordering the answer items, associating values indicative of a number or percentage of responders selecting each answer item, or the like. Process flow may then proceed to block 514.

At block 514, an aggregated and packaged response may be sent to the asker. In one embodiment, the transmission of the aggregated response from the answer server to the asker's client device may include the use of an instant messaging mechanism. SMS and other messaging mechanisms or communication mechanisms may be used in the transmission or reception of the response.

Process 500 may then return to a calling program. In one embodiment, processing may flow to block 314 of FIG. 3.

It will be understood that each block of the flowchart illustrations of FIGS. 3, 4, and 5, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustrations may also be performed concurrently with other blocks or combinations of blocks, or even in a different sequence than illustrated without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended

What is claimed as new and desired to be protected by Letters Patent of the United States is:

1. A method of processing a question from a client device comprising:
receiving, from the client device, the question;
determining a set of at least one target responders;
sending, to each target responder, a representation of the question;
receiving, from each of at least a portion of the target responders, a response;
aggregating the received responses to produce an aggregated response; and
sending the aggregated response to the client device.

2. The method of claim 1, wherein the question is at least one type of question selected from a group consisting of an open ended question, a YES/NO question, or a multiple choice question.

3. The method of claim 1, wherein aggregating the received responses comprises determining a number of responses corresponding to each of at least two answer items.

4. The method of claim 1, wherein the aggregated response includes at least two answer items and an indication of a ranking of each answer item based on a number of received responses corresponding to each answer item.

5. The method of claim 1, wherein determining the set of at least one target responders comprises selectively including a responder in the set based on at least one of a frequency of questions sent to the responder, a number of questions sent to the responder, or a time since sending a prior question to the responder.

6. The method of claim 1, further comprising selectively including a received response based on a timeout period.

7. The method of claim 1, further employing a timeout period for receiving responses, the timeout period having a duration that is less than one minute.

8. The method of claim 1, wherein at least one of receiving the question, sending the representation of the question, receiving the response, or sending the aggregated response is performed using an instant messaging mechanism.

9. The method of claim 1, wherein each of receiving the question, sending the representation of the question, receiving the response, and sending the aggregated response is performed using a communication mechanism to facilitate the client device sending the question and receiving the aggregated response within an instant messaging session.

10. The method of claim 1, wherein sending the representation of the question and receiving the response is performed within an instant messaging session.

11. The method of claim 1, wherein the client device is a mobile device.

12. A system for processing a question from a client device comprising:
at least one network device containing program logic to perform the method of claim 1; and
a plurality of responder devices in communication with the at least one network device, containing program logic to perform actions including:
receiving and displaying a question; and
sending an answer in an instant message.

13. A system for processing a question from a client device, comprising:
a transceiver to send and receive data over the network; and
a processor that is operative to perform actions, including:
receiving a question from the client device;
sending, to each of a plurality of target responders, a representation of the question;
receiving a plurality of responses from the plurality of target responders;
aggregating the plurality of responses to produce an aggregated response including at least two answer items; and
sending the aggregated response to the client device.

14. The system of claim 13, wherein aggregating the plurality of responses comprises determining a number of responses corresponding to each of at least two answer items.

15. The system of claim 13, the actions further comprising employing a timeout period for receiving responses, a client communication mechanism for communicating with the client device, and a responder communication mechanism for communicating with the target responders, wherein the timeout period, the client communication mechanism, and the responder communication mechanism facilitate sending the aggregated response substantially synchronously to receiving the question.

16. The system of claim 13, wherein the question is an open ended question and the aggregated response includes at least two answer items and an indication of a ranking of each answer item based on the received responses.

17. The system of claim 13, wherein at least one of receiving the question, sending the representation of the question, receiving the plurality of responses, or sending the aggregated response is performed using an instant messaging mechanism.

18. The system of claim 13, wherein the actions further comprise selectively sending an advertisement to the client device, based on the plurality of responses.

19. A network device for processing a question from a client device, comprising:
means for communicating with a client device;
means for communicating with a plurality of responder devices;
means for responding to a question from the client device by communicating with the plurality of responder devices, said means including logic to aggregate responses from the responder devices and provide an indication of a number of received responses corresponding to at least one answer in the aggregated response.

20. The network device of claim 19, wherein the means for communicating with the client device and the means for communicating with the plurality of responder devices facilitate providing the aggregate response in real time.
